(19) United States
(12) Patent Application Publication
(10) Pub. No.: US 2005/0211515 A1
(43) Pub. Date: Sep. 29, 2005

(54) Anti-vibration mount apparatus, exposure apparatus, and device manufacturing method

(75) Inventors: Tomoyasu Hata, Utsunomiya-shi (JP); Michio Yanagisawa, Utsunomiya-shi (JP); Takashi Maeda, Utsunomiya-shi (JP); Takashi Shibayama, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/088,757

(22) Filed: Mar. 25, 2005

(30) Foreign Application Priority Data
Mar. 29, 2004 (JP) 2004-096653

(51) Int. Cl. F15B 5/00

(52) U.S. Cl. 188/266.7

(57) ABSTRACT

An anti-vibration mount apparatus which suppresses vibration of a structure is disclosed. The apparatus comprises a gas spring which supports the structure, and a controller which controls an internal pressure of the gas spring. The controller comprises a primary chamber which communicates with a pressure source, a secondary chamber which communicates with the gas spring, a back-pressure chamber which communicates with the secondary chamber, a back-pressure control mechanism which has a nozzle communicating with the back-pressure chamber and a flapper facing the nozzle and controls a pressure in the back-pressure chamber via control of exhaust from the back-pressure chamber by changing a gap between the nozzle and the flapper, and a pressure control mechanism which controls a pressure in the secondary chamber via one of gas supply from the primary chamber to the secondary chamber and gas exhaust from the secondary chamber to outside caused in accordance with a pressure difference between the back-pressure chamber and the secondary chamber. The flapper has a tapered portion facing the nozzle, and the nozzle has a bore widened toward an outlet of the nozzle.

### FIELD OF THE INVENTION

The present invention relates to an anti-vibration mount technique applicable to a precision machinery such as an exposure apparatus.

### BACKGROUND OF THE INVENTION

An anti-vibration mount apparatus is used to remove vibrations of a precision machinery such as an exposure apparatus. Japanese Patent No. 3,219,198 relates to an air spring anti-vibration table. This reference describes an air spring anti-vibration table which comprises an electropneumatic converter for controlling the pneumatic pressure in a pilot room that balances with the pneumatic pressure in an air spring support leg. The air spring anti-vibration table controls the pneumatic pressure in the air spring support leg in accordance with variations in the pneumatic pressure in the pilot room. This anti-vibration table supplies air from a primary pneumatic pressure source to the pilot room by a vibrating valve to raise the pneumatic pressure in the pilot room, and exhausts air via an EX port in the pilot room by the vibrating valve to drop the pneumatic pressure in the pilot room. The pneumatic pressure in the air spring support leg is controlled by raising/dropping the pressure in the pilot room.

The anti-vibration/vibration suppression mount apparatus disclosed in Japanese Patent No. 3,219,198 can control the pneumatic pressure in the support leg while reducing the air consumption amount by the electropneumatic converter arrangement which controls the pneumatic pressure in a small-capacity pilot room that balances with the pneumatic pressure in the air spring support leg. In the electropneumatic converter, the specifications of a diaphragm used for the above-described pressure balance greatly influence the pressure control characteristic. That is, if a thick diaphragm is used, the control pressure greatly changes by a decrease in control resolution, an increase in hysteresis, and a change in temperature. If a thin diaphragm is used, these changes can be improved, but the control pressure varies owing to diaphragm vibrations caused by peripheral vibrations. In the electropneumatic converter, smooth sliding of the elevating valve and securement of airtightness of the pilot room trade off each other. When smoothness is enhanced, the pilot room becomes less airtight, and the control pressure greatly varies. When satisfactory airtightness is ensured, smooth sliding is not achieved, and the pressure precision and response characteristic degrade.

Japanese Patent Laid-Open No. 2003-269410 discloses an example of an electropneumatic converter which controls the pressure in the pilot room by a constant exhaust mechanism formed from a nozzle and flapper.

In the electropneumatic converter described in Japanese Patent Laid-Open No. 2003-269410, the opening of an exhaust path formed by the flapper and nozzle greatly changes (opening change characteristic is sensitive) upon movement of the flapper. Thus, it is difficult to increase the pressure control resolution (first problem).

Also in the electropneumatic converter described in Japanese Patent Laid-Open No. 2003-269410, the nozzle and flapper wear or deform owing to repetitive contact between the nozzle and the flapper. The opening of the gas exhaust path changes, and the set pressure changes along with this (second problem).

In the electropneumatic converter, satisfactory linearity of the control pressure to a command value cannot be obtained in switching from supply to exhaust of gas with respect to the secondary chamber or reverse switching. As a result, the control pressure deviates from a target pressure (third problem).

These problems arise when the above-described electropneumatic converter is applied to a precision machinery such as an anti-vibration/vibration suppression mount apparatus for a semiconductor manufacturing apparatus.

### SUMMARY OF THE INVENTION

The present invention has as its exemplified object to provide a novel high-accuracy anti-vibration mount technique.

According to the present invention, an anti-vibration mount apparatus which suppresses vibration of a structure, the apparatus comprising a gas spring which supports the structure, and a controller which controls an internal pressure of the gas spring. The controller comprises a primary chamber which communicates with a pressure source, a secondary chamber which communicates with the gas spring, a back-pressure chamber which communicates with the secondary chamber, a back-pressure control mechanism which has a nozzle communicating with the back-pressure chamber and a flapper facing the nozzle and controls a pressure in the back-pressure chamber via control of exhaust from the back-pressure chamber by changing a gap between the nozzle and the flapper, and a pressure control mechanism which controls a pressure in the secondary chamber via one of gas supply from the primary chamber to the secondary chamber and gas exhaust from the secondary chamber to outside caused in accordance with a pressure difference between the back-pressure chamber and the secondary chamber. The flapper has a tapered portion facing the nozzle, and the nozzle has a bore widened toward an outlet of the nozzle.

According to a preferred aspect of the present invention, the flapper and the nozzle have respective peripheral surfaces which face each other to prevent the tapered portion and an inner surface of the nozzle from contacting each other.

According to another preferred aspect of the present invention, the pressure control mechanism comprises a supply valve which gates a supply path from the primary chamber to the secondary chamber in accordance with the pressure difference between the back-pressure chamber and the secondary chamber, and an exhaust valve which gates an exhaust path from the secondary chamber to outside in accordance with the pressure difference between the back-pressure chamber and the secondary chamber.

According to still another preferred aspect of the present invention, the controller comprises a first diaphragm and a second diaphragm which partition the secondary chamber and the back-pressure chamber, and the pressure control mechanism is so configured as to exhaust gas in the secondary chamber to outside via a space formed by the first diaphragm and the second diaphragm.

According to still another preferred aspect of the present invention, the anti-vibration mount apparatus can further comprise a coupling member which couples the supply valve and the exhaust valve.

According to still another preferred aspect of the present invention, the anti-vibration mount apparatus can further comprise an electromagnetic actuator which drives the structure.

According to still another preferred aspect of the present invention, the electromagnetic actuator can be arranged in the gas spring.

According to still another preferred aspect of the present invention, the electromagnetic actuator can comprise a linear motor.

According to still another preferred aspect of the present invention, the electromagnetic actuator can comprise a voice coil motor.

According to still another preferred aspect of the present invention, the back-pressure control mechanism can have a driving mechanism which drives the flapper.

According to still another preferred aspect of the present invention, the anti-vibration mount apparatus can further comprise a flapper controller which controls the driving mechanism. The flapper controller can control the driving mechanism based on, e.g., information concerning vibration of the structure. The anti-vibration mount apparatus can further comprise a detector which detects at least one of a position and an acceleration of the structure as the information concerning vibration of the structure. The information concerning vibration of the structure may include information concerning motion of a movable member included in the structure.

According to still another aspect of the present invention, the anti-vibration mount apparatus can further comprise actuator controller which controls the electromagnetic actuator. The actuator controller can control the electromagnetic actuator based on, e.g., information concerning vibration of the structure. The anti-vibration mount apparatus can further comprise a detector which detects, e.g., at least one of a position and an acceleration of the structure as the information concerning vibration of the structure. The information on vibrations of the structure may include information on motion of a movable member included in the structure.

According to the present invention, an exposure apparatus which exposes a substrate to a pattern comprises the anti-vibration mount apparatus adapted to support a part of the exposure apparatus.

According to the present invention, a device manufacturing method comprises steps of exposing a substrate to a pattern using the exposure apparatus, and developing the exposed substrate.

The present invention can provide an anti-vibration mount technique capable of high-precision control.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view schematically showing the arrangement of an anti-vibration mount apparatus according to a preferred embodiment of the present invention;

FIG. 2 is a block diagram showing a control system when the anti-vibration mount apparatus shown in FIG. 1 is applied to an exposure apparatus;

FIG. 3 is a view showing an example of the arrangement of a pressure controller;

FIG. 4 is a view showing an example of the arrangement of a nozzle/flapper mechanism;

FIG. 5 is a view schematically showing the arrangement of a hybrid actuator including an air spring and linear motor;

FIG. 6 is a view showing an example of the arrangement of an anti-vibration mount apparatus having a plurality of hybrid actuators each including an air spring and linear motor;

FIGS. 7A to 7C are views schematically showing the arrangement of an exposure apparatus to which the anti-vibration mount apparatus shown in FIG. 6 or the like is applied;

FIG. 8 is a flowchart showing the flow of the whole manufacturing process of a semiconductor device; and

FIG. 9 is a flowchart showing the detailed flow of a wafer process.

### DETAILED DESCRIPTION OF THE PREFERRED EMBODIMENT

A preferred embodiment of the present invention will be described below with reference to the accompanying drawings.

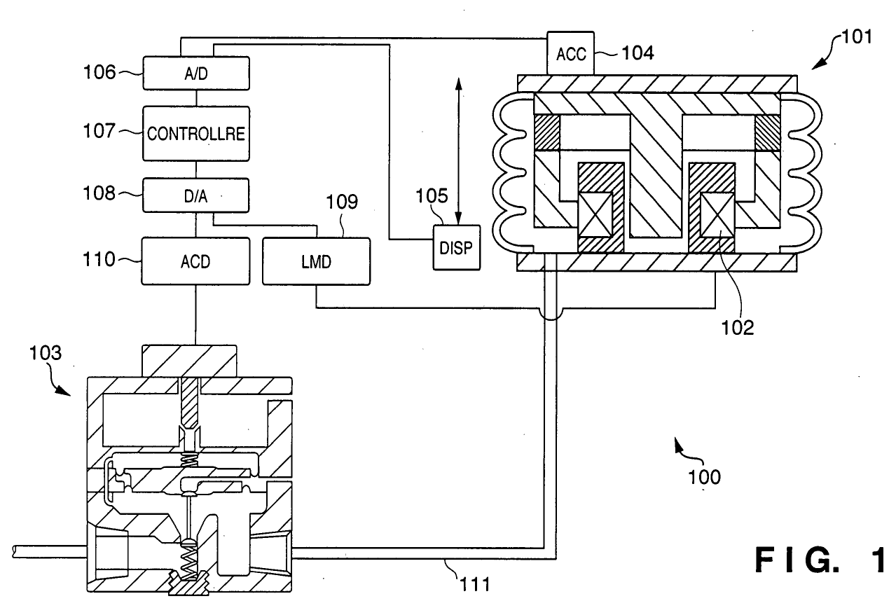

FIG. 1 is a view schematically showing the arrangement of an anti-vibration mount apparatus according to the preferred embodiment of the present invention. An anti-vibration mount apparatus 100 is typically installed between the floor and a supported structure. The anti-vibration mount apparatus 100 comprises, for example, an air spring 101, linear motor (linear motion type electromagnetic actuator) 102, pressure controller 103, accelerometer 104, displacement gauge 105, A/D converter 106, controller 107, D/A converter 108, linear motor driver 109, and pressure controller driver 110. The anti-vibration mount apparatus 100 drives the linear motor 102 and controls the pressure in the air spring 101 on the basis of the displacement and acceleration of the output end of the anti-vibration mount apparatus 100 or those of the supported structure coupled to the output end, thereby maintaining the position of the supported structure at a predetermined position and removing vibrations. In the arrangement example shown in FIG. 1, a hybrid actuator is comprised of the air spring 101 serving as the first actuator and the linear motor 102 serving as the second actuator, but the second actuator is not always necessary.

In general, an anti-vibration mount apparatus having a plurality of single axis hybrid actuators each including the air spring 101 and actuator 102 is arranged to remove vibrations of a supported structure. For example, in an arrangement which removes vibrations from a supported structure at six degrees of freedom, a plurality of displacement gauges 105 and a plurality of accelerometers 104 are so arranged as to detect the displacement of the supported structure at six degrees of freedom, and a plurality of hybrid actuators are driven on the basis of outputs from the displacement gauges 105 and accelerometers 104. Detection of the displacement at six degrees of freedom preferably uses six displacement gauges 105, and detection of the acceleration at six degrees of freedom preferably uses six accelerometers 104.

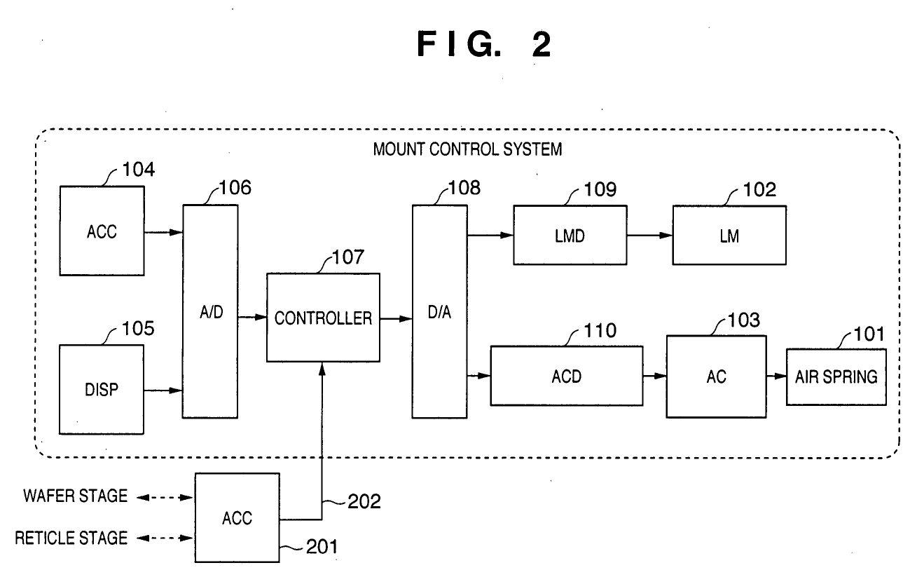

FIG. 2 is a block diagram showing a control system when the anti-vibration mount apparatus 100 shown in FIG. 1 is applied to an exposure apparatus. The A/D converter 106 samples analog output signals (detection signals) from the accelerometer 104 and displacement gauge 105 which respectively measure the acceleration and displacement of the output end (in this case, the upper end of the air spring 101 or hybrid actuator) of the anti-vibration mount apparatus 100, and converts the signals into digital signals. The controller 107 arithmetically processes the detection signal which is converted into a digital signal by the A/D converter 106, and stage information 202 provided from a stage controller 201 which controls a wafer stage and reticle stage, generating actuator driving command data (digital data). The actuator driving command data includes data for driving the air spring 101 serving as the first actuator and data for driving the linear motor 102 serving as the second actuator. The D/A converter 108 converts the actuator driving command data into an analog driving signal, and supplies the signal to the pressure controller driver 110 and linear motor driver 109.

The pressure controller driver 110 controls the pressure controller 103 in accordance with a pressure control driving signal provided from the D/A converter 108, and controls the pneumatic pressure in the air spring 101. The linear motor driver 109 supplies a current to the coil of the linear motor 102 in accordance with a linear motor driving signal provided from the D/A converter 108, and drives the linear motor 102.

The controller 107 is made up of various arithmetic units such as a DSP (Digital Signal Processor). Detection signals output from the accelerometer 104 and displacement gauge 105 are sampled by the A/D converter 106, and provided to the controller 107, as described above. The controller 107 executes a compensation arithmetic process and generates actuator driving command data on the basis of sample data and the stage information 202 so as to cancel the acceleration and displacement of the output end of the anti-vibration mount apparatus 100, i.e., maintain the output end at a predetermined position without any vibration.

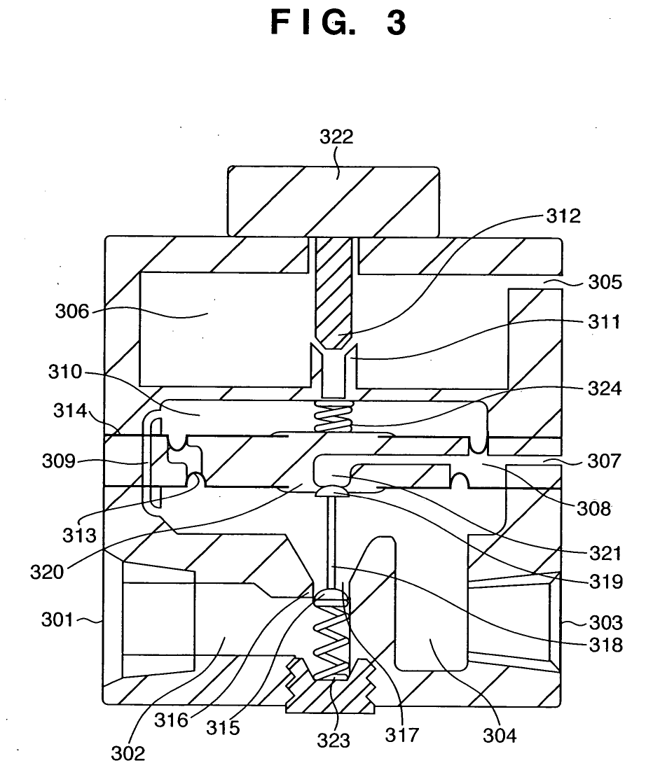

FIG. 3 is a view showing an example of the arrangement of the pressure controller 103. In the arrangement example shown in FIG. 3, the pressure controller 103 comprises a primary port 301, primary chamber 302, secondary port 303, secondary chamber 304, constant exhaust port 305, constant exhaust chamber 306, exhaust port 307, exhaust chamber 308, through path 309, back-pressure chamber 310, nozzle 311, flapper 312, first diaphragm 313, second diaphragm 314, communicating valve 315, communicating valve seat 316, communicating path 317, communicating member 318, on-off valve 319, on-off valve seat 320, on-off path 321, electric actuator 322, first spring 323, and second spring 324.

The secondary chamber 304 and back-pressure chamber 310 communicate with each other via the through path 309. The flapper 312 is vertically driven by the electric actuator 322 in accordance with a driving signal provided from the pressure controller driver 110. A pressure fluid provided from a pressure source to the primary port 301 is supplied from the primary chamber 302 to the secondary port 303 via a gap formed between the communicating valve 315 and the communicating valve seat 316.

The pressure fluid in the secondary chamber 304 flows into the back-pressure chamber 310 via the through path 309, and passes through the gap between the nozzle 311 and the flapper 312 which are set above the back-pressure chamber 310. The pressure fluid is then discharged into air from the constant exhaust port 305 formed in the constant exhaust chamber 306 which is always evacuated in controlling the pressure in the secondary chamber 304 (controlling the air spring 101).

When the gap (flow path) between the nozzle 311 and the flapper 312 is narrowed by the electric actuator 322, the pressure in the back-pressure chamber 310 rises and presses down the second diaphragm 314. Then, the second diaphragm 314, first diaphragm 313, and valve element 318 are integrally displaced downward, and the communicating valve 315 is separated from the communicating valve seat 316. The pressure fluid is supplied from the primary chamber 302 to the secondary chamber 304 to raise the pressure in the secondary chamber 304. That is, the pressure in the secondary chamber 304 can be increased by narrowing the gap (flow path) between the nozzle 311 and the flapper 312 by the electric actuator 322.

The secondary chamber 304 communicates with a port 506 of the air spring 101 via the secondary port 303 and a flow path 111. By controlling the pressure in the secondary chamber 304, the pressure in the air spring 101 can be controlled to displace the output end of the air spring 101 (output end of the anti-vibration mount apparatus 100).

When the secondary pressure in the secondary chamber 304 exceeds a set pressure (pressure defined by the position of the flapper 312), the secondary pressure presses up the first diaphragm 313, and the on-off valve 319 is separated from the on-off valve seat 320. The secondary chamber 304 communicates with the on-off path 321 and exhaust chamber 308 via the gap (flow path) between the on-off valve 319 and the on-off valve seat 320. Accordingly, the pressure fluid in the secondary chamber 304 is discharged from the exhaust port 307 into the exhaust chamber 308, decreasing the secondary pressure.

To the contrary, when the gap (fluid path) between the nozzle 311 and the flapper 312 is widened by the electric actuator 322, the pressure in the back-pressure chamber 310 drops. The secondary pressure in the secondary chamber 304 presses up the first diaphragm 313, and the on-off valve 319 is separated from the on-off valve seat 320. The secondary chamber 304 communicates with the on-off path 321 and exhaust chamber 308 via the gap (fluid path) between the on-off valve 319 and the on-off valve seat 320. The pressure fluid in the secondary chamber 304 is discharged from the exhaust port 307 into the exhaust chamber 308, decreasing the secondary pressure. Also, as the second diaphragm 314 moves up, the gap between the communicating valve 315 and the communicating valve seat 316 narrows, and the pressure fluid supplied from the primary chamber 302 to the secondary chamber 304 decreases. That is, the pressure in the secondary chamber 304 can be decreased by widening the gap (fluid path) between the nozzle 311 and the flapper 312 by the electric actuator 322.

In this manner, the electric actuator 322 controls the gap between the nozzle 311 and the flapper 312 to control the pressure in the small-capacity back-pressure chamber 310, thereby controlling the pressures in the secondary chamber 304 and air spring 101.

The electric actuator 322, nozzle 311, and flapper 312 constitute a back-pressure control mechanism which controls the pressure in the back-pressure chamber 310. The communicating valve 315, communicating valve seat 316, on-off valve 319, on-off valve seat 320, first diaphragm 313, second diaphragm 314, and the like constitute a supply/exhaust control mechanism which controls supply of gas from the primary chamber 302 to the secondary chamber 304 and exhaust of gas from the secondary chamber 304 to the outside, and controls the pressure in the secondary chamber 304 in accordance with the pressure difference between the back-pressure chamber 310 and the secondary chamber 304. The communicating valve 315 functions as a supply control valve for controlling supply of gas from the primary chamber 302 to the secondary chamber 304, and the on-off valve 319 functions as an exhaust control valve for controlling exhaust of gas from the secondary chamber 304 to the outside.

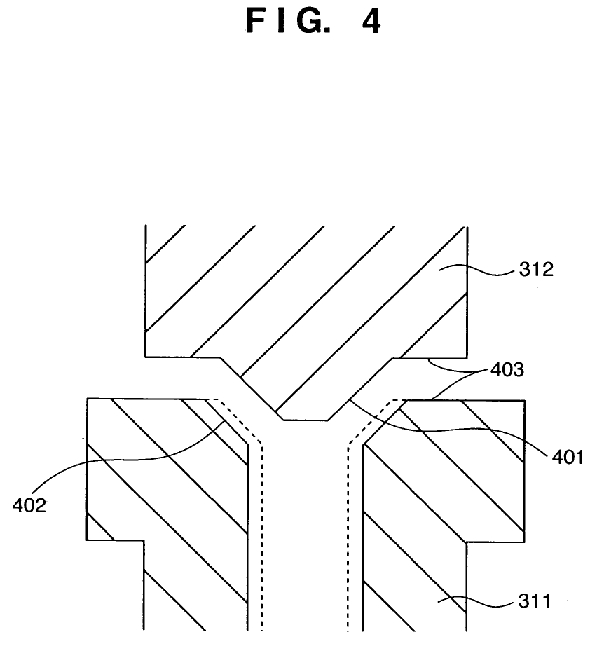

FIG. 4 is a view showing an example of the arrangement of the nozzle/flapper mechanism (back-pressure control mechanism). The nozzle 311 has a tapered portion 402 whose outlet diameter is larger than the inlet diameter, and the flapper 312 has a tapered core (tapered portion) 401 which faces the tapered section of the nozzle 311. This structure enables accurate pressure control of the back-pressure chamber 310. In other words, the above-described structure of the nozzle/flapper mechanism makes it possible to decrease (moderate) a change in the opening of an exhaust path formed by the flapper and nozzle upon movement of the flapper and increase the pressure control resolution.

The tapered core 401 of the flapper 312 is preferably set smaller than the tapered portion 402 of the nozzle 311 in size in a direction perpendicular to the moving direction of the flapper 312 so that the nozzle 311 and flapper 312 contact on only a contact surface 403 formed at the periphery of the nozzle 311. With this structure, the repetitively operating nozzle 311 and flapper 312 wear on only the contact surface 403. Variations in pressure control characteristic by wear can be reduced, and problems such as deformation of the nozzle or flapper by contact and vibrations of the flapper by the deformation can be reduced.

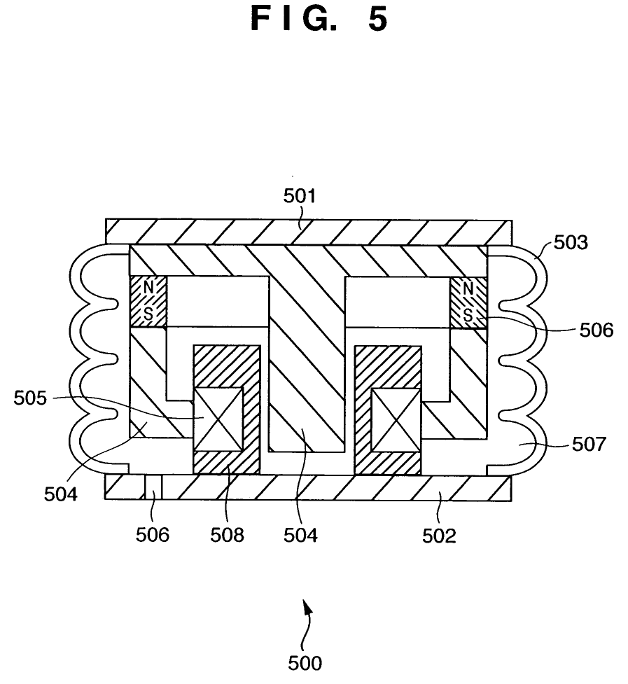

FIG. 5 is a view schematically showing the arrangement of the hybrid actuator including the air spring 101 and linear motor 102. A hybrid actuator 500 comprises a first end 501 which supports a structure subjected to control or vibration removal, and a second end 502 which is coupled to a reference structure (e.g., the floor or a member set on the floor). The first end 501 and second end 502 are typically arranged in parallel. The first end 501 and second end 502 define an internal chamber (sealed chamber) 507 together with a multistage rubber bellows 503 serving as a sealing member which is formed with flexibility, (and also together with other members, as needed). The sealing member may be made of another material or formed from a cylinder or the like. The first end 501 and second end 502 can take, e.g., a disk shape.

A magnetic circuit yoke 504 which forms a magnetic circuit is fixed to the first end 501, and part of the magnetic circuit comprises a permanent magnet 506. The first end 501 can move along the driving axis (vertical direction in FIG. 5) integrally with the magnetic circuit yoke 504 and permanent magnet 506. A coil 505 is fixed to the second end 502 by a support member 508 also functioning as a yoke.

The permanent magnet 506 is magnetized along the driving axis, and the magnetic circuit yoke 504 forms a magnetic field in the radial direction of the coil 505. The first end (output end) 501 can be moved along the driving axis (moved in the vertical or elevating direction in FIG. 5) by supplying a current to the coil 505 by the linear motor driver 109. This arrangement can provide high thrust transmission efficiency. In an anti-vibration mount apparatus using only an electropneumatic converter and air spring, the control pressure deviates from a target pressure because satisfactory linearity of the control pressure to a command value cannot be obtained in switching from supply to exhaust of gas to the secondary chamber or reverse switching. By additionally adopting the electromagnetic actuator (linear motor), degradation of the anti-vibration performance caused by the above problem can be suppressed, and high-precision anti-vibration control can be performed.

As described above, the linear motor 102 is assembled into the multistage rubber bellows (sealing member) 503 with a so-called VCM (Voice Coil Motor) structure. This structure can downsize the hybrid actuator, ensure necessary rigidity, and simplify a recovery mechanism for outgassing from the coil wire and magnet.

In the arrangement example shown in FIG. 5, the first end 501 may be coupled to the reference structure (e.g., the floor or a member set on the floor), and the second end 502 may support a structure subjected to control or vibration removal.

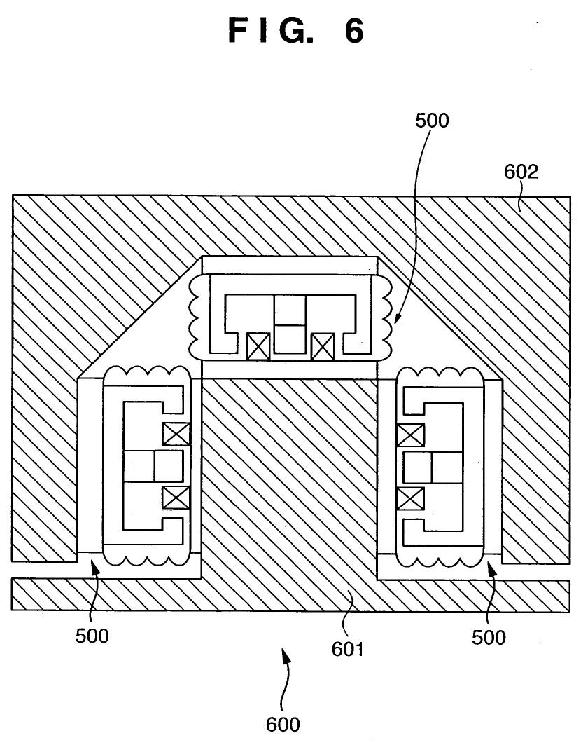

FIG. 6 is a view showing an example of the arrangement of an anti-vibration mount apparatus having three hybrid actuators 500 each including the air spring 101 and linear motor 102. In this arrangement example, an anti-vibration mount apparatus 600 has two hybrid actuators for removing horizontal vibrations, and one hybrid actuator for removing vertical vibrations. The two hybrid actuators arranged to remove horizontal vibrations are driven by driving signals of opposite polarities. This driving method is implemented by forming the linear motor driver 109 shown in FIG. 1 into a two-channel type or parallel- or series-connecting the coils 505 of the linear motors 102 at opposite polarities. Also, the arrangement is preferably simplified by using the pressure controller 103 of a differential pressure control type. Two pressure controllers 103 may be employed and driven at opposite polarities.

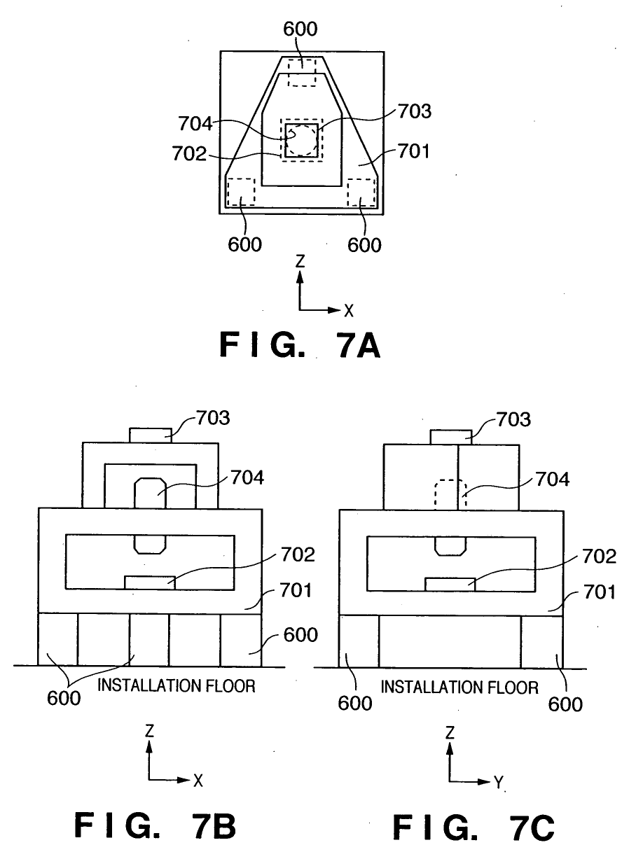

FIGS. 7A to 7C are views schematically showing the arrangement of an exposure apparatus to which the anti-vibration mount apparatus shown in FIG. 6 or the like is applied. The exposure apparatus is so arranged as to transfer or draw a pattern on a wafer (substrate) on a wafer stage (substrate stage) via a projection optical system. As the exposure method, various methods such as step & repeat (so-called stepper) and step & scan (so-called scanner) can be adopted. Wafer exposure can use a charged particle beam such as an electron beam in addition to light.

The exposure apparatus comprises a structure 701 such as a surface plate or frame, a wafer stage 702, a reticle stage 703, a lens barrel (projection optical system) 704, and the anti-vibration mount apparatus 600. The wafer stage 702, reticle stage 703, and lens barrel (projection optical system) 704 are supported by the structure 701.

The anti-vibration mount apparatus 600 installed between the structure 701 and the floor (or a support coupled to or set on the floor) removes vibrations of the structure 701 on the anti-vibration mount apparatus 600 and those of a member supported by the structure 701, and enables precise positioning of the wafer stage 702 and reticle stage 703.

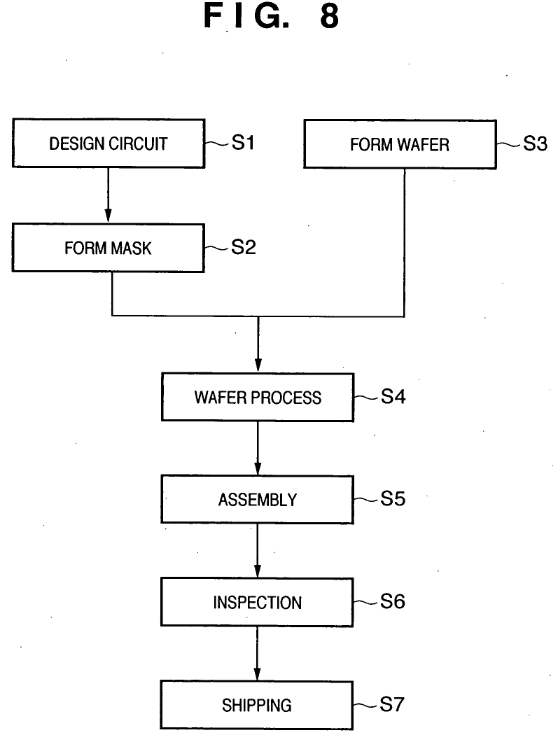

A semiconductor device manufacturing process using the above-described exposure apparatus will be explained. FIG. 8 is a flowchart showing the flow of the whole manufacturing process of a semiconductor device. In step 1 (circuit design), the circuit of a semiconductor device is designed. In step 2 (mask formation), a mask having the designed circuit pattern is formed. In step 3 (wafer formation), a wafer is formed using a material such as silicon. In step 4 (wafer process) called a pre-process, an actual circuit is formed on the wafer by lithography using the mask and wafer. Step 5 (assembly) called a post-process is the step of forming a semiconductor chip by using the wafer formed in step 4, and includes an assembly process (dicing and bonding) and packaging process (chip encapsulation). In step 6 (inspection), the semiconductor device manufactured in step 5 undergoes inspections such as an operation confirmation test and durability test. After these steps, the semiconductor device is completed and shipped (step 7).

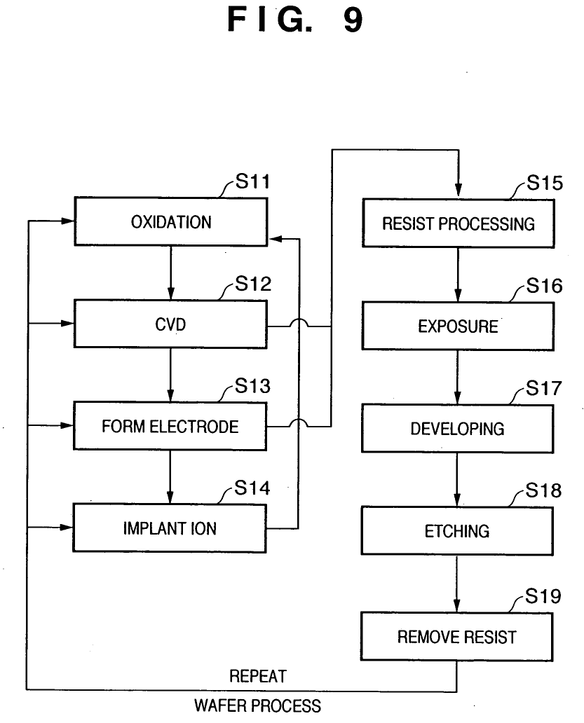

FIG. 9 is a flowchart showing the detailed flow of the wafer process. In step 11 (oxidation), the wafer surface is oxidized. In step 12 (CVD), an insulating film is formed on the wafer surface. In step 13 (electrode formation), an electrode is formed on the wafer by vapor deposition. In step 14 (ion implantation), ions are implanted in the wafer. In step 15 (resist processing), a photosensitive agent is applied to the wafer. In step 16 (exposure), the circuit pattern is transferred to the wafer by the above-mentioned exposure apparatus. In step 17 (developing), the exposed wafer is developed. In step 18 (etching), the resist is etched except the developed resist image. In step 19 (resist removal), an unnecessary resist after etching is removed. These steps are repeated to form multiple circuit patterns on the wafer.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent application No. 2004-096653 filed on Mar. 29, 2004, the entire contents of which are hereby incorporated by reference herein.

1. An anti-vibration mount apparatus which suppresses vibration of a structure, said apparatus comprising:
a gas spring which supports the structure; and
a controller which controls an internal pressure of said gas spring,
said controller comprising
a primary chamber which communicates with a pressure source,
a secondary chamber which communicates with said gas spring,
a back-pressure chamber which communicates with said secondary chamber,
a back-pressure control mechanism which has a nozzle communicating with said back-pressure chamber and a flapper facing said nozzle and controls a pressure in said back-pressure chamber via control of exhaust from said back-pressure chamber by changing a gap between said nozzle and said flapper, and
a pressure control mechanism which controls a pressure in said secondary chamber via one of gas supply from said primary chamber to said secondary chamber and gas exhaust from said secondary chamber to outside caused in accordance with a pressure difference between said back-pressure chamber and said secondary chamber,
wherein said flapper has a tapered portion facing said nozzle, and
said nozzle has a bore widened toward an outlet of said nozzle.

2. An apparatus according to claim 1, wherein said flapper and said nozzle have respective peripheral surfaces which face each other to prevent said tapered portion and an inner surface of said nozzle from contacting each other.

3. An apparatus according to claim 1, wherein said pressure control mechanism comprises
a supply valve which gates a supply path from said primary chamber to said secondary chamber in accordance with the pressure difference between said back-pressure chamber and said secondary chamber, and
an exhaust valve which gates an exhaust path from said secondary chamber to outside in accordance with the pressure difference between said back-pressure chamber and said secondary chamber.

4. An apparatus according to claim 1, wherein said controller comprises a first diaphragm and a second diaphragm which partition said secondary chamber and said back-pressure chamber, and said pressure control mechanism is so configured as to exhaust gas in said secondary chamber to outside via a space formed by said first diaphragm and said second diaphragm.

5. An apparatus according to claim 3, further comprising a coupling member which couples said supply valve and said exhaust valve.

6. An apparatus according to claim 1, further comprising an electromagnetic actuator which drives the structure.

7. An apparatus according to claim 6, wherein said electromagnetic actuator is arranged in said gas spring.

8. An apparatus according to claim 6, wherein said electromagnetic actuator comprises a linear motor.

9. An apparatus according to claim 6, wherein said electromagnetic actuator comprises a voice coil motor.

10. An apparatus according to claim 1, wherein said back-pressure control mechanism has a driving mechanism which drives said flapper.

11. An apparatus according to claim 10, further comprising a flapper controller which controls said driving mechanism.

12. An apparatus according to claim 11, wherein said flapper controller controls said driving mechanism based on information concerning vibration of the structure.

13. An apparatus according to claim 12, further comprising a detector which detects at least one of a position and an acceleration of the structure as the information concerning vibration of the structure.

14. An apparatus according to claim 12, wherein the information concerning vibration of the structure includes information concerning motion of a movable member included in the structure.

15. An apparatus according to claim 6, further comprising an actuator controller which controls said electromagnetic actuator.

16. An apparatus according to claim 15, wherein said actuator controller controls said electromagnetic actuator based on information concerning vibration of the structure.

17. An apparatus according to claim 16, further comprising a detector which detects at least one of a position and an acceleration of the structure as the information concerning vibration of the structure.

18. An apparatus according to claim 16, wherein the information concerning vibration of the structure includes information concerning motion of a movable member included in the structure.

19. An exposure apparatus which exposes a substrate to a pattern, said apparatus comprising:
an anti-vibration mount apparatus, as defined in claim 1, to support a part of said exposure apparatus.

20. A device manufacturing method comprising steps of:
exposing a substrate to a pattern using an exposure apparatus as defined in claim 19; and
developing the exposed substrate.
